(19) United States
(12) Patent Application Publication
(10) Pub. No.: US 2014/0253590 A1
(43) Pub. Date: Sep. 11, 2014

(54) METHODS AND APPARATUS FOR USING OPTICAL CHARACTER RECOGNITION TO PROVIDE AUGMENTED REALITY

(71) Applicants: Bradford H. Needham, North Plains, OR (US); Kevin C. Wells, Portland, OR (US)

(72) Inventors: Bradford H. Needham, North Plains, OR (US); Kevin C. Wells, Portland, OR (US)

(21) Appl. No.: 13/994,489

(22) PCT Filed: Mar. 6, 2013
(86) PCT No.: PCT/US13/29427

§ 371 Date: Jun. 14, 2013

(51) Int. Cl. G06T 19/00; G06K 9/18

(52) U.S. Cl. CPC G06T 19/006; G06K 9/18
USPC 345/633

(57) ABSTRACT

A processing system uses optical character recognition (OCR) to provide augmented reality (AR). The processing system automatically determines, based on video of a scene, whether the scene includes a predetermined AR target. In response to determining that the scene includes the AR target, the processing system automatically retrieves an OCR zone definition associated with the AR target. The OCR zone definition identifies an OCR zone. The processing system automatically uses OCR to extract text from the OCR zone. The processing system uses results of the OCR to obtain AR content which corresponds to the text from the OCR zone. The processing system automatically causes that AR content to be presented in conjunction with the scene. Other embodiments are described and claimed.

### TECHNICAL FIELD

Embodiments described herein generally relate to data processing and in particular to methods and apparatus for using optical character recognition to provide augmented reality.

### BACKGROUND

A data processing system may include features which allow the user of the data processing system to capture and display video. After video has been captured, video editing software may be used to alter the contents of the video, for instance by superimposing a title. Furthermore, recent developments have led to the emergence of a field known as augmented reality (AR). As explained by the “Augmented reality” entry in the online encyclopedia provided under the “WIKIPEDIA” trademark, AR “is a live, direct or indirect, view of a physical, real-world environment whose elements are augmented by computer-generated sensory input such as sound, video, graphics or GPS data.” Typically, with AR, video is modified in real time. For instance, when a television (TV) station is broadcasting live video of an American football game, the TV station may use a data processing system to modify the video in real time. For example, the data processing system may superimpose a yellow line across the football field to show how far the offensive team must move the ball to earn a first down.

In addition, some companies are working on technology that allows AR to be used on a more personal level. For instance, some companies are developing technology to enable a smart phone to provide AR, based on video captured by the smart phone. This type of AR may be considered an example of mobile AR. The mobile AR world consists largely of two different types of experiences: geolocation-based AR and vision-based AR. Geolocation-based AR uses global positioning system (GPS) sensors, compass sensors, cameras, and/or other sensors in the user's mobile device to provide a “heads-up” display with AR content that depicts various geolocated points of interest. Vision-based AR may use some the same kinds of sensors to display AR content in context with real-world objects (e.g., magazines, postcards, product packaging) by tracking the visual features of these objects. AR content may also be referred to as digital content, computer-generated content, virtual content, virtual objects, etc.

However, it is unlikely that vision-based AR will become ubiquitous before many associated challenges are overcome.

Typically, before a data processing system can provide vision-based AR, the data processing system must detect something in the video scene that, in effect, tells the data processing system that the current video scene is suitable for AR. For instance, if the intended AR experience involves adding a particular virtual object to a video scene whenever the scene includes a particular physical object or image, the system must first detect the physical object or image in the video scene. The first object may be referred to as an “AR-recognizable image” or simply as an “AR marker” or an “AR target.”

One of the challenges in the field of vision-based AR is that it is still relatively difficult for developers to create images or objects that are suitable as AR targets. An effective AR target contains a high level of visual complexity and asymmetry. And if the AR system is to support more than one AR target, each AR target must be sufficiently distinct from all of the other AR targets. Many images or objects that might at first seem usable as AR targets actually lack one or more of the above characteristics.

Furthermore, as an AR application supports greater numbers of different AR targets, the image recognizing portion of the AR application may require greater amounts of processing resources (e.g., memory and processor cycles) and/or the AR application may take more time to recognize images. Thus, scalability can be a problem.

### BRIEF DESCRIPTION OF THE DRAWINGS

FIG. 1 is a block diagram of an example data processing system that uses optical character recognition to provide augmented reality (AR);

FIG. 2A is a schematic diagram showing an example OCR zone within a video image;

FIG. 2B is a schematic diagram showing example AR content within a video image;

FIG. 3 is a flowchart of an example process for configuring an AR system;

FIG. 4 is a flowchart of an example process for providing AR; and

FIG. 5 is a flowchart of an example process for retrieving AR content from a content provider.

### DESCRIPTION OF EMBODIMENTS

As indicated above, an AR system may use an AR target to determine that a corresponding AR object should be added to a video scene. If the AR system can be made to recognize many different AR targets, the AR system can be made to provide many different AR objects. However, as indicated above, it is not easy for developers to create suitable AR targets. In addition, with conventional AR technology, it could be necessary to create many different unique targets to provide a sufficiently useful AR experience.

Some of the challenges associated with creating numerous different AR targets may be illustrated in the context of a hypothetical application that uses AR to provide information to people using a public bus system. The operator of the bus system may want to place unique AR targets on hundreds of bus stop signs, and the operator may want an AR application to use AR to notify riders at each bus stop when the next bus is expected to arrive at that stop. In addition, the operator may want the AR targets to serve as a recognizable mark to the riders, more or less like a trademark. In other words, the operator may want the AR targets to have a recognizable look that is common to all the AR targets for that operator while also being easily distinguished by the human viewer from marks, logos, or designs used by other entities.

According to the present disclosure, instead of requiring a different AR target for each different AR object, the AR system may associate an optical character recognition (OCR) zone with an AR target, and the system may use OCR to extract text from the OCR zone. According to one embodiment, the system uses the AR target and results from the OCR to determine an AR object to be added to the video. Further details about OCR may be found on the website for Quest Visual, Inc. at questvisual.com/us/, with regard to the application known as Word Lens. Further details about AR may be found on the website for the ARToolKit software library at www.hit1.washington.edu/artoolkit/documentation.

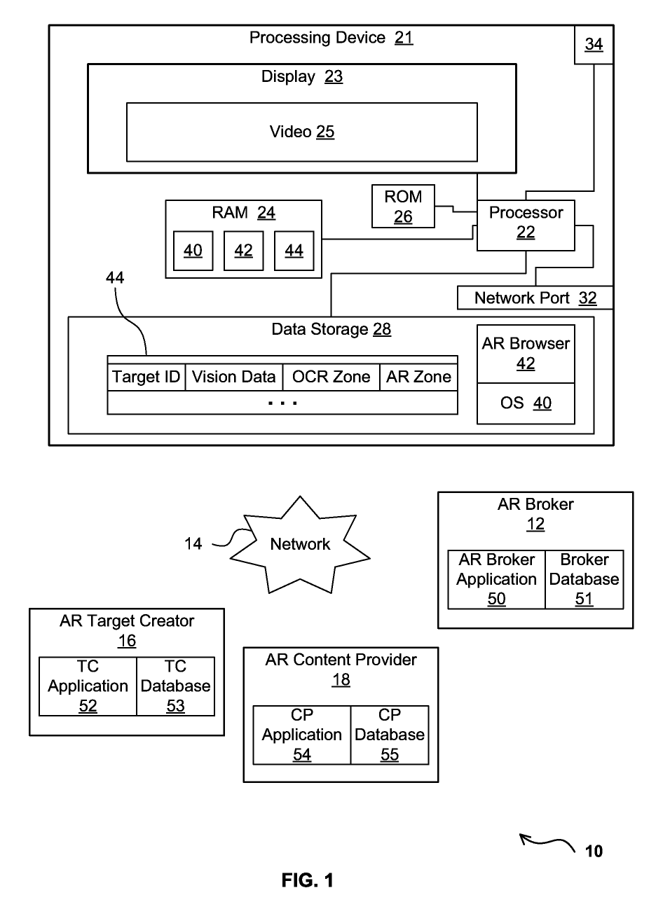

FIG. 1 is a block diagram of an example data processing system that uses optical character recognition to provide augmented reality (AR). In the embodiment of FIG. 1, the data processing system 10 includes multiple processing devices which cooperate to provide an AR experience for the user. Those processing devices include a local processing device 21 operated by the user or consumer, a remote processing device 12 operated by an AR broker, another remote processing device 16 operated by an AR mark creator, and another remote processing device 18 operated by an AR content provider. In the embodiment of FIG. 1, the local processing device 21 is a mobile processing device (e.g., a smart phone, a tablet, etc.) and remote processing devices 12, 16, and 18 are laptop, desktop, or server systems. But in other embodiments, any suitable type of processing device may be used for of each of the processing devices described above.

As used herein, the terms “processing system” and “data processing system” are intended to broadly encompass a single machine, or a system of communicatively coupled machines or devices operating together. For instance, two or more machines may cooperate using one or more variations on a peer-to-peer model, a client/server model, or a cloud computing model to provide some or all of the functionality described herein. In the embodiment of FIG. 1, the processing devices in processing system 10 connect to or communicate with each other via one or more networks 14. The networks may include local area networks (LANs) and/or wide area networks (WANs) (e.g., the Internet).

For ease of reference, the local processing device 21 may be referred to as “the mobile device,” “the personal device,” “the AR client,” or simply “the consumer.” Similarly, the remote processing device 12 may be referred to as “the AR broker,” the remote processing device 16 may be referred to as “the AR target creator,” and the remote processing device 18 may be referred to as “the AR content provider.” As described in greater detail below, the AR broker may help the AR target creator, the AR content provider, and the AR browser to cooperate. The AR browser, the AR broker, the AR content provider, and the AR target creator may be referred to collectively as the AR system. Further details about AR brokers, AR browsers, and other components of one of more AR systems may be found on the website of the Layar company at www.layar.com and/or on the website of metaio GmbH/metaio Inc. (“the metaio company”) at www.metaio.com.

In the embodiment of FIG. 1, the mobile device 21 features at least one central processing unit (CPU) or processor 22, along with random access memory (RAM) 24, read-only memory (ROM) 26, a hard disk drive or other nonvolatile data storage 28, a network port 32, a camera 34, and a display panel 23 responsive to or coupled to the processor. Additional input/output (I/O) components (e.g., a keyboard) may also be responsive to or coupled to the processor. In one embodiment, the camera (or another 1.0 component in the mobile device) is capable of processing electromagnetic wavelengths beyond those detectable with the human eye, such as infrared. And the mobile device may use video that involves those wavelengths to detect AR targets.

The data storage contains an operating system (OS) 40 and an AR browser 42. The AR browser may be an application that enables the mobile device to provide an AR experience for the user. The AR browser may be implemented as an application that is designed to provide AR services for only a single AR content provider, or the AR browser may be capable of providing AR services for multiple AR content providers. The mobile device may copy some or all of the OS and some or all of the AR browser to RAM for execution, particularly when using the AR browser to provide AR. In addition, the data storage includes an AR database 44, some or all of which may also be copied to RAM to facilitate operation of the AR browser. The AR browser may use the display panel to display a video image 25 and/or other output. The display panel may also be touch sensitive, in which case the display panel may also be used for input.

The processing devices for the AR broker, the AR mark creator, and the AR content provider may include features like those described above with regard to the mobile device. In addition, as described in greater detail below, the AR broker may contain an AR broker application 50 and a broker database 51, the AR target creator (TC) may contain a TC application 52 and a TC database 53, and the AR content provider (CP) may contain a CP application 54 and a CP database 55. The AR database 44 in the mobile computer may also be referred to as a client database 44.

As described in greater detail below, in addition to creating an AR target, an AR target creator may define one or more OCR zones and one or more AR content zones, relative to the AR target. For purposes of this disclosure, an OCR zone is an area or space within a video scene from which text is to be extracted, and an AR content zone is an area or space within a video scene where AR content is to be presented. An AR content zone may also be referred to simply as an AR zone. In one embodiment, the AR target creator defines the AR zone or zones. In another embodiment, the AR content provider defines the AR zone or zones. As described in greater detail below, a coordinate system may be used to define an AR zone relative to an AR target.

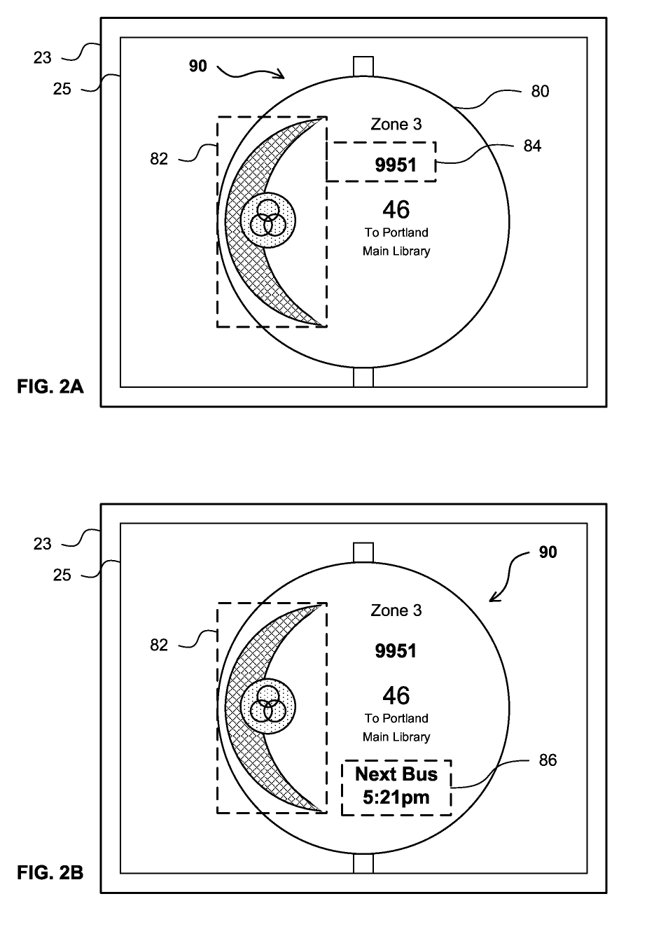

FIG. 2A is a schematic diagram showing an example OCR zone and an example AR target within a video image. In particular, the illustrated video image 25 includes a target 82, the boundary of which is depicted by dashed lines for purposes of illustration. And the image includes an OCR zone 84, located adjacent to the right border of the target and extending to the right a distance approximately equal to the width of the target. The boundary of the OCR zone 84 is also shown with dashed lines for purposes of illustration. Video 25 depicts output from the mobile device produced while the camera is directed at a bus stop sign 90. However, in at least one embodiment, the dashed lines that are shown in FIG. 2A would not actually appear on the display.

FIG. 2B is a schematic diagram showing example AR output within a video image or scene. In particular, as described in greater detail below, FIG. 2B depicts AR content (e.g., the expected time of arrival of the next bus) presented by the AR browser within an AR zone 86. Thus, AR content which corresponds to text extracted from the OCR zone is automatically caused to be presented in conjunction with (e.g., within) the scene. As indicated above, the AR zone may be defined in terms of a coordinate system. And the AR browser may use that coordinate system to present the AR content. For example, the coordinate system may include an origin (e.g., the upper-left corner of the AR target), a set of axes (e.g., X for horizontal movement in the plane of the AR Target, Y for vertical movement in the same plane, and Z for movement perpendicular to the plane of the AR Target), and a size (e.g., “AR target width=0.22 meters”). The AR target creator or the AR content provider may define an AR zone by specifying desired values for AR zone parameters which correspond to, or constitute, the components of the AR coordinate system. Accordingly, the AR browser may use the values in the AR zone definition to present the AR content relative to the AR coordinate system. An AR coordinate system may also be referred to simply as an AR origin. In one embodiment, a coordinate system with a Z axis is used for three-dimensional (3D) AR content, and a coordinate system without a Z axis is used for two-dimensional (2D) AR content.

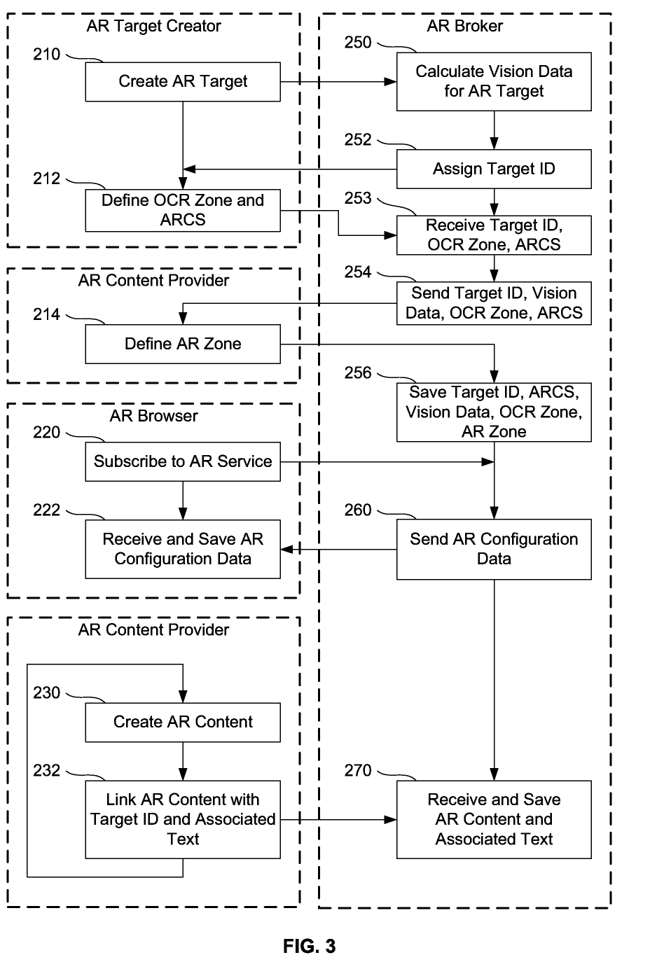

FIG. 3 is a flowchart of an example process for configuring the AR system with information that can be used to produce an AR experience (e.g., like the experience depicted in FIG. 2B). The illustrated process starts with a person using the TC application to create an AR target, as shown at block 210. The AR target creator and the AR content provider may operate on the same processing device, or they may be controlled by the same entity, or the AR target creator may create targets for the AR content provider. The TC application may use any suitable techniques to create or define AR targets. An AR target definition may include a variety of values to specify the attributes of the AR target, including, for instance, the real-world dimensions of the AR target. After the AR target has been created, the TC application may send a copy of that target to the AR broker, and the AR broker application may calculate vision data for the target, as shown at block 250. The vision data includes information about some of the features of the target. In particular, the vision data includes information that the AR browser can use to determine whether or not the target appears within video being captured by the mobile device, as well as information to calculate the pose (e.g., the position and orientation) of the camera relative to the AR coordinate system. Accordingly, when the vision data is used by the AR browser, it may be referred to as predetermined vision data. The vision data may also be referred to as image recognition data. With regard to the AR target shown in FIG. 2A, the vision data may identify characteristics such as higher-contrast edges and corners (acute angles) that appear in the image, and their positions relative to each other, for example.

Also, as shown at block 252, the AR broker application may assign a label or identifier (ID) to the target, to facilitate future reference. The AR broker may then return the vision data and the target ID to the AR target creator.

As shown at block 212, the AR target creator may then define the AR coordinate system for the AR target, and the AR target creator may use that coordinate system to specify the bounds of an OCR zone, relative to the AR target. In other words, the AR target creator may define boundaries for an area expected to contain text that can be recognized using OCR, and the results of the OCR can be used to distinguish between different instances of the target. In one embodiment, the AR target creator specifies the OCR zone with regard to a model video frame that models or simulates a head-on view of the AR target. The OCR zone constitutes an area within a video frame from which text is to be extracted using OCR. Thus, the AR target may serve as a high-level classifier for identifying the relevant AR content, and text from the OCR zone may serve as a low-level classifier for identifying the relevant AR content. The embodiment of FIG. 2A depicts an OCR zone designed to contain a bus stop number.

The AR target creator may specify the bounds of the OCR zone relative to the location of the target or particular features of the target. For instance, for the target shown in FIG. 2A, the AR target creator may define the OCR zone as follows: a rectangle that shares the same plane as the target and that has (a) a left border located adjacent to the right border of the target, (b) a width extending to the right a distance approximately equal to the width of the target, (c) an upper border near the upper right corner of the target, and (d) a height which extends down a distance approximately fifteen percent of the height of the target. Alternatively, the OCR zone may be defined relative to the AR coordinate system, for example a rectangle with an upper-left corner at coordinates {X=0.25 m, Y=−0.10 m, Z=0.0 m} and a lower-right corner at coordinates {X=0.25 m, Y=−0.30 m, Z=0.0 m}. Alternatively the OCR zone may be defined as a circular area with the center in the plane of the AR target, at coordinates {X=0.30 m, Y=−0.20 m} and radius of 0.10 m. In general, the OCR Zone may be defined by any formal description of a set of closed areas in a surface relative to the AR coordinate system. The TC application may then send the target ID and the specifications for the AR coordinate system (ARCS) and the OCR zone to the AR broker, as shown at block 253.

As shown at block 254, the AR broker may then send the target ID, the vision data, the OCR zone definition, and the ARCS to the CP application.

The AR content provider may then use the CP application to specify one or more zones within the scene where AR content should be added, as shown at block 214. In other words, the CP application may be used to define an AR zone, such as the AR zone 86 of FIG. 2B. The same kind of approach that is used to define the OCR zone may be used to define the AR zone, or any other suitable approach may be used. For instance, the CP application may specify the location for displaying the AR content relative to the AR coordinate system, and as indicated above, the AR coordinate system may define the origin to be located at the upper-left corner of the AR target, for instance. As indicated by the arrow leading from block 214 to block 256, the CP application may then send the AR zone definition with the target ID to the AR broker.

The AR broker may save the target ID, the vision data, the OCR zone definition, the AR zone definition, and the ARCS in the broker database, as shown at block 256. The target ID, the zone definitions, the vision data, the ARCS, and any other predefined data for an AR target may be referred to as the AR configuration data for that target. The TC application and the CP application may also save some or all of the AR configuration data in TC database and the CP database, respectively.

In one embodiment, the target creator uses the TC application to create the target image and the OCR zone or zones in the context of a model video frame configured as if the camera pose is oriented head on to the target. Likewise, the CP application may define the AR zone or zones in the context of a model video frame configured as if the camera pose is oriented head on to the target. The vision data may allow the AR browser to detect the target even if the live scene received by the AR browser does not have the camera pose oriented head on to the target.

As shown at block 220, after one or more AR targets have been created, a person or “consumer” may then use the AR browser to subscribe to AR services from the AR broker. In response, the AR broker may automatically send the AR configuration data to the AR browser, as shown at block 260. The AR browser may then save that configuration data in the client database, as shown at block 222. If the consumer is only registering for access to AR from a single content provider, the AR broker may send only configuration data for that content provider to the AR browser application. Alternatively, the registration may not be limited to a single content provider, and the AR broker may send AR configuration data for multiple content providers to the AR browser, to be saved in the client database.

In addition, as shown at block 230, the content provider may create AR content. And as shown at block 232, the content provider may link that content with a particular AR target and particular text associated with that target. In particular, the text may correspond to the results to be obtained when OCR is performed on the OCR zone associated with that target. The content provider may send the target ID, the text, and the corresponding AR content to the AR broker. The AR broker may save that data in the broker database, as shown at block 270. In addition or alternatively, as described in greater detail below, the content provider may provide AR content dynamically, after the AR browser has detected a target and contacted the AR content provider, possibly via the AR broker.

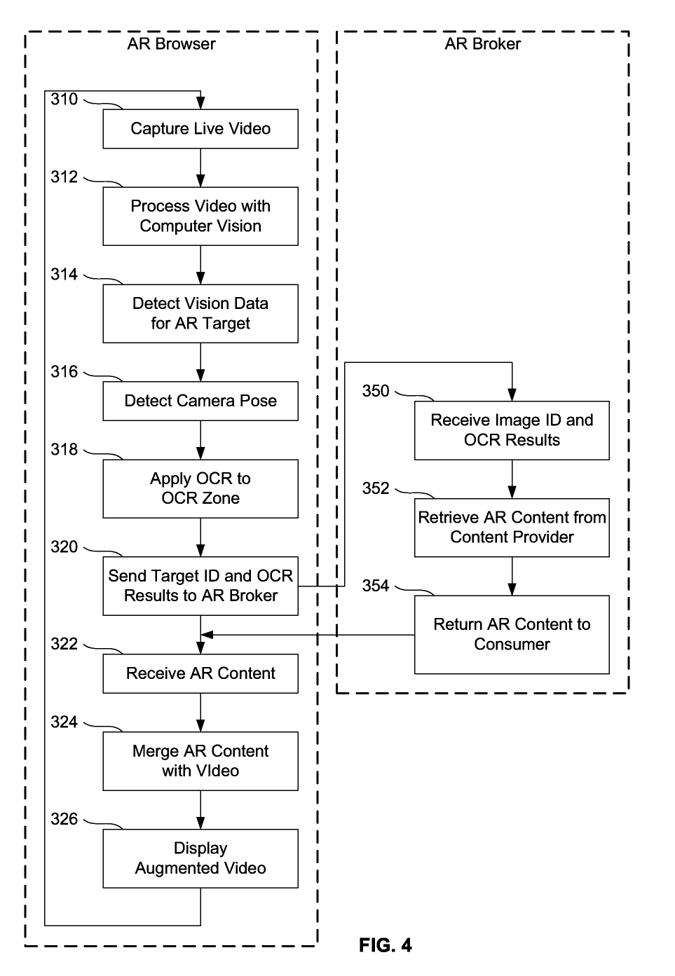

FIG. 4 is a flowchart of an example process for providing AR content. The process starts with the mobile device capturing live video and feeding that video to the AR browser, as shown at block 310. As indicated at block 312, the AR browser processes that video using a technology known as computer vision. Computer vision enables the AR browser to compensate for variances that naturally occur in live video, relative to a standard or model image. For instance, computer vision may enable the AR browser to recognize a target in the video, based on the predetermined vision data for that target, as shown at block 314, even though the camera is disposed at an angle to the target, etc. As shown at block 316, if an AR target is detected, the AR browser may then determine the camera pose (e.g., the position and orientation of the camera relative to the AR coordinate system associated with the AR target). After determining the camera pose, the AR browser may compute the location within the live video of the OCR zone, and the AR browser may apply OCR to that zone, as shown at block 318. Further details for one or more approaches for calculating the camera pose (e.g., for calculating the position and orientation of the camera relative to an AR image) may be found in the article entitled “Tutorial 2: Camera and Marker Relationships” at www.hit1.washington.edu/artoolkit/documentation/tutorialcamera.htm. For instance, a transformation matrix may be used to convert the current camera view of a sign into a head-on view of the same sign. The transformation matrix may then be used calculate the area of the converted image to perform OCR on, based on the OCR zone definition. Further details for performing those kinds of transformation may also be found at opencv.org. Once the camera pose has been determined, an approach like the one described on the website for the Tesseract OCR engine at code.google.com/p/tesseract-ocr may be used to perform OCR on the transformed, head-on view image.

As indicated at blocks 320 and 350, the AR browser may then send the target ID and the OCR results to the AR broker. For example, referring again to FIG. 2A, the AR browser may send the target ID for the target that is being used by the bus operator along with the text “9951” to the AR broker.

As shown at block 352, the AR broker application may then use the target ID and the OCR results to retrieve corresponding AR content. If the corresponding AR content has already been provided to the AR broker by the content provider, the AR broker application may simply send that content to the AR browser. Alternatively, the AR broker application may dynamically retrieve the AR content from the content provider in response to receiving the target ID and the OCR results from the AR browser.

Although FIG. 2B describes AR content in the form of text, the AR content can be in any medium, including without limitation text, images, photographs, video, 3D objects, animated 3D objects, audio, haptic output (e.g., vibration or force feedback), etc. In the case of non-visual AR content such as audio or haptic feedback, the device may present that AR content in the appropriate medium in conjunction with the scene, rather than merging the AR content with the video content.

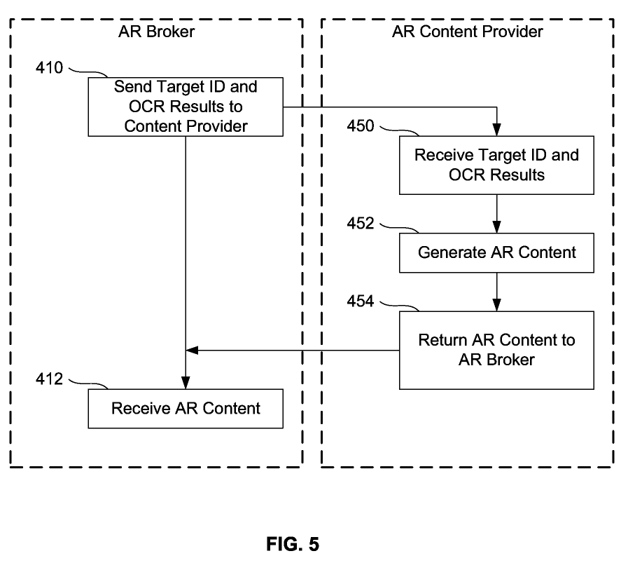

FIG. 5 is a flowchart of an example process for retrieving AR content from a content provider. In particular, FIG. 5 provides more details for the operations illustrated in block 352 of FIG. 4. FIG. 5 starts with the AR broker application sending the target ID and the OCR results to the content provider, as shown at blocks 410 and 450. The AR broker application may determine which content provider to contact, based on the target ID. In response to receiving the target ID and the OCR results, the CP application may generate AR content, as shown at block 452. For instance, in response to receiving bus stop number 9951, the CP application may determine the expected time of arrival (ETA) for the next bus at that bus stop, and the CP application may return that ETA, along with rendering information, to the AR broker for use as AR content, as shown at blocks 454 and 412.

Referring again to FIG. 4, once the AR broker application has obtained the AR content, the AR broker application may return that content to the AR browser, as shown at blocks 354 and 322. The AR browser may then merge the AR content with the video, as shown at block 324. For instance, the rendering information may describe the font, font color, font size, and relative coordinates of the baseline of the first character of the text to enable the AR browser to superimpose the ETA of the next bus in the AR zone, over or in place of any content that might actually be in that zone on the real-world sign. The AR browser may then cause this augmented video to be shown on the display device, as shown at block 326 and in FIG. 2B. Thus, the AR browser may use the calculated pose of the camera relative to the AR target, the AR Content, and the live video frames to place the AR content into the video frames and send them to the display.

In FIG. 2B, the AR content is shown as a two-dimensional (2D) object. In other embodiments, the AR content may include planar images placed in 3D relative to the AR coordinate system, video similarly placed, 3D objects, haptic or audio data to be played when a given AR Target is identified, etc.

An advantage of one embodiment is that the disclosed technology makes it easier for content providers to deliver different AR content for different situations. For example, if the AR content provider is the operator of a bus system, the content provider may be able to provide different AR content for each different bus stop without using a different AR target for each bus stop. Instead, the content provider can use a single AR target along with text (e.g., a bus stop number) positioned within a predetermined zone relative to the target. Consequently, the AR target may serve as a high-level classifier, the text may serve as a low level classifier, and both levels of classifiers may be used to determine the AR content to be provided in any particular situation. For instance, the AR target may indicate that, as a high-level category, the relevant AR content for a particular scene is content from a particular content provider. The text in the OCR zone may indicate that, as a low level category, the AR content for the scene is AR content relevant to a particular location. Thus, the AR target may identify a high-level category of AR content, and the text on the OCR zone may identify a low-level category of AR content. And it may be very easy for the content provider to create new low-level classifiers, to provide customized AR content for new situations or locations (e.g., in case more bus stops are added to the system).

Since the AR browser uses both the AR target (or the target ID) and the OCR results (e.g., some or all of the text from the OCR zone) to obtain AR content, the AR target (or target ID) and the OCR results may be referred to collectively as a multi-level AR content trigger.

Another advantage is that an AR target may also be suitable for use as a trademark for the content provider, and the text on the OCR zone may also be legible to, and useful for, the customers of the content provider.

In one embodiment, the content provider or target creator may define multiple OCR zones for each AR target. This set of OCR zones may enable the use of signs with different shapes and/or different arrangements of content, for instance. For example, the target creator may define a first OCR zone located to the right of an AR target, and a second OCR zone located below the AR target. Accordingly, when an AR browser detects an AR target, the AR browser may then automatically perform OCR on multiple zones, and the AR browser may send some or all of those OCR results to the AR broker, to be used to retrieve AR content. Also, the AR coordinate system enables the content provider to provide whatever content in whatever media and position relative to the AR Target is appropriate.

In light of the principles and example embodiments described and illustrated herein, it will be recognized that the illustrated embodiments can be modified in arrangement and detail without departing from such principles. For instance, some of the paragraphs above refer to vision-based AR. However, the teachings herein may also be used to advantage with other types of AR experiences. For instance, the present teaching may be used with so-called Simultaneous Location And Mapping (SLAM) AR, and the AR marker may be a three-dimensional physical object, rather than a two-dimensional image. For example, a distinctive doorway or figure (e.g., a bust of Mickey Mouse or Isaac Newton) may be used as a three-dimensional AR target. Further information about SLAM AR may be found in the article about the metaio company at http://techcrunch.com/2012/10/18/metaios-new-sdk-allows-slam-mapping-from-1000-feet/.

Also, some of the paragraphs above refer to an AR browser and an AR broker that are relatively independent from the AR content provider. However, in other embodiments, the AR browser may communicate directly with the AR content provider. For example, the AR content provider may supply the mobile device with a custom AR application, and that application may serve as the AR browser. Then, that AR browser may send target IDs, OCR text, etc., directly to the content provider, and the content provider may send AR content directly to the AR browser. Further details on custom AR applications may be found on the website of the Total Immersion company at www.t-immersion.com.

Also, some of the paragraphs above refer to an AR target that is suitable for use as a trademark or logo, since the AR target makes a meaningful impression in a human viewer and the AR target is easily recognizable to the human viewer and easily distinguished by the human viewer from other images or symbols. However, other embodiments may use other types of AR targets, including without limitation fiduciary markers such as those described at www.artoolworks.com/support/library/Using_ARToolKit_NFT_with_fiducial_markers_(versio n_{—}3.x). Such fiduciary markers may also be referred to “fiducials” or “AR tags.”

Also, the foregoing discussion has focused on particular embodiments, but other configurations are contemplated. Also, even though expressions such as “an embodiment,” “one embodiment,” “another embodiment,” or the like are used herein, these phrases are meant to generally reference embodiment possibilities, and are not intended to limit the invention to particular embodiment configurations. As used herein, these phrases may reference the same embodiment or different embodiments, and those embodiments are combinable into other embodiments.

Any suitable operating environment and programming language (or combination of operating environments and programming languages) may be used to implement components described herein. As indicated above, the present teachings may be used to advantage in many different kinds of data processing systems. Example data processing systems include, without limitation, distributed computing systems, supercomputers, high-performance computing systems, computing clusters, mainframe computers, mini-computers, client-server systems, personal computers (PCs), workstations, servers, portable computers, laptop computers, tablet computers, personal digital assistants (PDAs), telephones, handheld devices, entertainment devices such as audio devices, video devices, audio/video devices (e.g., televisions and set top boxes), vehicular processing systems, and other devices for processing or transmitting information. Accordingly, unless explicitly specified otherwise or required by the context, references to any particular type of data processing system (e.g., a mobile device) should be understood as encompassing other types of data processing systems, as well. Also, unless expressly specified otherwise, components that are described as being coupled to each other, in communication with each other, responsive to each other, or the like need not be in continuous communication with each other and need not be directly coupled to each other. Likewise, when one component is described as receiving data from or sending data to another component, that data may be sent or received through one or more intermediate components, unless expressly specified otherwise. In addition, some components of the data processing system may be implemented as adapter cards with interfaces (e.g., a connector) for communicating with a bus. Alternatively, devices or components may be implemented as embedded controllers, using components such as programmable or non-programmable logic devices or arrays, application-specific integrated circuits (ASICs), embedded computers, smart cards, and the like. For purposes of this disclosure, the term “bus” includes pathways that may be shared by more than two devices, as well as point-to-point pathways.

This disclosure may refer to instructions, functions, procedures, data structures, application programs, configuration settings, and other kinds of data. As described above, when the data is accessed by a machine, the machine may respond by performing tasks, defining abstract data types or low-level hardware contexts, and/or performing other operations. For instance, data storage, RAM, and/or flash memory may include various sets of instructions which, when executed, perform various operations. Such sets of instructions may be referred to in general as software. In addition, the term “program” may be used in general to cover a broad range of software constructs, including applications, routines, modules, drivers, subprograms, processes, and other types of software components. Also, applications and/or other data that are described above as residing on a particular device in one example embodiment may, in other embodiments, reside on one or more other devices. And computing operations that are described above as being performed on one particular device in one example embodiment may, in other embodiments, be executed by one or more other devices.

It should also be understood that the hardware and software components depicted herein represent functional elements that are reasonably self-contained so that each can be designed, constructed, or updated substantially independently of the others. In alternative embodiments, many of the components may be implemented as hardware, software, or combinations of hardware and software for providing the functionality described and illustrated herein. For example, alternative embodiments include machine accessible media encoding instructions or control logic for performing the operations of the invention. Such embodiments may also be referred to as program products. Such machine accessible media may include, without limitation, tangible storage media such as magnetic disks, optical disks, RAM, ROM, etc. For purposes of this disclosure, the term “ROM” may be used in general to refer to non-volatile memory devices such as erasable programmable ROM (EPROM), electrically erasable programmable ROM (EEPROM), flash ROM, flash memory, etc. In some embodiments, some or all of the control logic for implementing the described operations may be implemented in hardware logic (e.g., as part of an integrated circuit chip, a programmable gate array (PGA), an ASIC, etc.). In at least one embodiment, the instructions for all components may be stored in one non-transitory machine accessible medium. In at least one other embodiment, two or more non-transitory machine accessible media may be used for storing the instructions for the components. For instance, instructions for one component may be stored in one medium, and instructions another component may be stored in another medium. Alternatively, a portion of the instructions for one component may be stored in one medium, and the rest of the instructions for that component (as well instructions for other components), may be stored in one or more other media. Instructions may also be used in a distributed environment, and may be stored locally and/or remotely for access by single or multi-processor machines.

Also, although one or more example processes have been described with regard to particular operations performed in a particular sequence, numerous modifications could be applied to those processes to derive numerous alternative embodiments of the present invention. For example, alternative embodiments may include processes that use fewer than all of the disclosed operations, process that use additional operations, and processes in which the individual operations disclosed herein are combined, subdivided, rearranged, or otherwise altered.

In view of the wide variety of useful permutations that may be readily derived from the example embodiments described herein, this detailed description is intended to be illustrative only, and should not be taken as limiting the scope of coverage.

The following examples pertain to further embodiments.

Example A1 is an automated method for using OCR to provide AR. The method includes automatically determining, based on video of a scene, whether the scene includes a predetermined AR target. In response to determining that the scene includes the AR target, an OCR zone definition associated with the AR target is automatically retrieved. The OCR zone definition identifies an OCR zone. In response to retrieving the OCR zone definition associated with the AR target, OCR is automatically used to extract text from the OCR zone. Results of the OCR are used to obtain AR content which corresponds to the text extracted from the OCR zone. The AR content which corresponds to the text extracted from the OCR zone is automatically caused to be presented in conjunction with the scene.

Example A2 includes the features of Example A1, and the OCR zone definition identifies at least one feature of the OCR zone relative to at least one feature of the AR target.

Example A3 includes the features of Example A1, and the operation of automatically retrieving an OCR zone definition associated with the AR target comprises using a target identifier for the AR target to retrieve the OCR zone definition from a local storage medium. Example A3 may also include the features of Example A2.

Example A4 includes the features of Example A1, and the operation of using results of the OCR to determine AR content which corresponds to the text extracted from the OCR zone comprises (a) sending a target identifier for the AR target and at least some of the text from the OCR zone to a remote processing system; and (b) after sending the target identifier and at least some of the text from the OCR zone to the remote processing system, receiving the AR content from the remote processing system. Example A4 may also include the features of Example A2 or Example A3, or the features of Example A2 and Example A3.

Example A5 includes the features of Example A1, and the operation of using results of the OCR to determine AR content which corresponds to the text extracted from the OCR zone comprises (a) sending OCR information to the remote processing system, wherein the OCR information corresponds to the text extracted from the OCR zone; and (b) after sending the OCR information to the remote processing system, receiving the AR content from the remote processing system. Example A5 may also include the features of Example A2 or Example A3, or the features of Example A2 and Example A3.

Example A6 includes the features of Example A1, and the AR target serves as a high-level classifier. Also, at least some of the text from the OCR zone serves as a low-level classifier. Example A6 may also include (a) the features of Example A2, A3, A4, or A5; (b) the features of any two or more of Examples A2, A3, and A4; or (c) the features of any two or more of Examples A2, A3, and A5.

Example A7 includes the features of Example A6, and the high-level classifier identifies the AR content provider.

Example A8 includes the features of Example A1, and the AR target is two dimensional. Example A8 may also include (a) the features of Example A2, A3, A4, A5, A6, or A7; (b) the features of any two or more of Examples A2, A3, A4, A6, and A7; or (c) the features of any two or more of Examples A2, A3, A5, A6, and A7.

Example B1 is a method for implementing a multi-level trigger for AR content. That method involves selecting an AR target to serve as a high-level classifier for identifying relevant AR content. In addition an OCR zone for the selected AR target is specified. The OCR zone constitutes an area within a video frame from which text is to be extracted using OCR. Text from the OCR zone is to serve as a low-level classifier for identifying relevant AR content.

Example B2 includes the features of Example B1, and the operation of specifying an OCR zone for the selected AR target comprises specifying at least one feature of the OCR zone, relative to at least one feature of the AR target.

Example C1 is a method for processing a multi-level trigger for AR content. That method involves receiving a target identifier from an AR client. The target identifier identifies a predefined AR target as having been detected in a video scene by the AR client. In addition, text is received from the AR client, wherein the text corresponds to results from OCR performed by the AR client on an OCR zone associated with the predefined AR target in the video scene. AR content is obtained, based on the target identifier and the text from the AR client. The AR content is sent to the AR client.

Example C2 includes the features of Example C1, and the operation of obtaining AR content, based on the target identifier and the text from the AR client, comprises dynamically generating the AR content, based at least in part on the text from the AR client.

Example C3 includes the features of Example C1, and the operation of obtaining AR content, based on the target identifier and the text from the AR client, comprises automatically retrieving the AR content from a remote processing system.

Example C4 includes the features of Example C1, and the text received from the AR client comprises at least some of the results from the OCR performed by the AR client. Example C4 may also include the features of Example C2 or Example C3.

Example D1 is at least one machine accessible medium comprising computer instructions for supporting AR enhanced with OCR. The computer instructions, in response to being executed on a data processing system, enable the data processing system to perform a method according to any of Examples A1-A7, B1-B2, and C1-C4.

Example E1 is a data processing system that supports AR enhanced with OCR. The data processing system includes a processing element, at least one machine accessible medium responsive to the processing element, and computer instructions stored at least partially in the at least one machine accessible medium. In response to being executed, the computer instructions enable the data processing system to perform a method according to any of Examples A1-A7, B1-B2, and C1-C4.

Example F1 is a data processing system that supports AR enhanced with OCR. The data processing system includes means for performing a method according to any of Examples A1-A7, B1-B2, and C1-C4.

Example G1 is at least one machine accessible medium comprising computer instructions for supporting AR enhanced with OCR. The computer instructions, in response to being executed on a data processing system, enable the data processing system to automatically determine, based on video of a scene, whether the scene includes a predetermined AR target. The computer instructions also enable the data processing system to automatically retrieve an OCR zone definition associated with the AR target, in response to determining that the scene includes the AR target. The OCR zone definition identifies an OCR zone. The computer instructions also enable the data processing system to automatically use OCR to extract text from the OCR zone, in response to retrieving the OCR zone definition associated with the AR target. The computer instructions also enable the data processing system to use results of the OCR to obtain AR content which corresponds to the text extracted from the OCR zone. The computer instructions also enable the data processing system to automatically cause the AR content which corresponds to the text extracted from the OCR zone to be presented in conjunction with the scene.

Example G2 includes the features of Example G1, and the OCR zone definition identifies at least one feature of the OCR zone relative to at least one feature of the AR target.

Example G3 includes the features of Example G1, and the operation of automatically retrieving an OCR zone definition associated with the AR target comprises using a target identifier for the AR target to retrieve the OCR zone definition from a local storage medium. Example G3 may also include the features of Example G2.

Example G4 includes the features of Example G1, and the operation of using results of the OCR to determine AR content which corresponds to the text extracted from the OCR zone comprises (a) sending a target identifier for the AR target and at least some of the text from the OCR zone to a remote processing system; and (b) after sending the target identifier and at least some of the text from the OCR zone to the remote processing system, receiving the AR content from the remote processing system. Example G4 may also include the features of Example G2 or Example G3, or the features of Example G2 and Example G3.

Example G5 includes the features of Example G1, and the operation of using results of the OCR to determine AR content which corresponds to the text extracted from the OCR zone comprises (a) sending OCR information to the remote processing system, wherein the OCR information corresponds to the text extracted from the OCR zone; and (b) after sending the OCR information to the remote processing system, receiving the AR content from the remote processing system. Example G5 may also include the features of Example G2 or Example G3, or the features of Example G2 and Example G3.

Example G6 includes the features of Example G1, and the AR target serves as a high-level classifier. Also, at least some of the text from the OCR zone serves as a low-level classifier. Example G6 may also include (a) the features of Example G2, G3, G4, or G5; (b) the features of any two or more of Examples G2, G3, and G4; or (c) the features of any two or more of Examples G2, G3, and G5.

Example G7 includes the features of Example G6, and the high-level classifier identifies the AR content provider.

Example G8 includes the features of Example G1, and the AR target is two dimensional. Example G8 may also include (a) the features of Example G2, G3, G4, G5, G6, or G7; (b) the features of any two or more of Examples G2, G3, G4, G6, and G7; or (c) the features of any two or more of Examples G2, G3, G5, G6, and G7.

Example H1 is at least one machine accessible medium comprising computer instructions for implementing a multi-level trigger for AR content. The computer instructions, in response to being executed on a data processing system, enable the data processing system to select an AR target to serve as a high-level classifier for identifying relevant AR content. The computer instructions also enable the data processing system to specify an OCR zone for the selected AR target, wherein the OCR zone constitutes an area within a video frame from which text is to be extracted using OCR, and wherein text from the OCR zone is to serve as a low-level classifier for identifying relevant AR content.

Example H2 includes the features of Example H1, and the operation of specifying an OCR zone for the selected AR target comprises specifying at least one feature of the OCR zone, relative to at least one feature of the AR target.

Example I1 is at least one machine accessible medium comprising computer instructions for implementing a multi-level trigger for AR content. The computer instructions, in response to being executed on a data processing system, enable the data processing system to receive a target identifier from an AR client. The target identifier identifies a predefined AR target as having been detected in a video scene by the AR client. The computer instructions also enable the data processing system to receive text from the AR client, wherein the text corresponds to results from OCR performed by the AR client on an OCR zone associated with the predefined AR target in the video scene. The computer instructions also enable the data processing system to obtain AR content, based on the target identifier and the text from the AR client, and to send the AR content to the AR client.

Example I2 includes the features of Example I1, and the operation of obtaining AR content, based on the target identifier and the text from the AR client, comprises dynamically generating the AR content, based at least in part on the text from the AR client.

Example I3 includes the features of Example I1, and the operation of obtaining AR content, based on the target identifier and the text from the AR client, comprises automatically retrieving the AR content from a remote processing system.

Example I4 includes the features of Example I1, and the text received from the AR client comprises at least some of the results from the OCR performed by the AR client. Example I4 may also include the features of Example I2 or Example I3.

Example J1 is a data processing system that includes a processing element, at least one machine accessible medium responsive to the processing element, and an AR browser stored at least partially in the at least one machine accessible medium. In addition, an AR database is stored at least partially in the at least one machine accessible medium. The AR database contains an AR target identifier associated with an AR target and an OCR zone definition associated with the AR target. The OCR zone definition identifies an OCR zone. The AR browser is operable to automatically determine, based on video of a scene, whether the scene includes the AR target. The AR browser is also operable to automatically retrieve the OCR zone definition associated with the AR target, in response to determining that the scene includes the AR target. The AR browser is also operable to automatically use OCR to extract text from the OCR zone, in response to retrieving the OCR zone definition associated with the AR target. The AR browser is also operable to use results of the OCR to obtain AR content which corresponds to the text extracted from the OCR zone. The AR browser is also operable to automatically cause the AR content which corresponds to the text extracted from the OCR zone to be presented in conjunction with the scene.

Example J2 includes the features of Example J1, and the OCR zone definition identifies at least one feature of the OCR zone relative to at least one feature of the AR target.

Example J3 includes the features of Example J1, and the AR browser is operable to use a target identifier for the AR target to retrieve the OCR zone definition from a local storage medium. Example J3 may also include the features of Example J2.

Example J4 includes the features of Example J1, and the operation of using results of the OCR to determine AR content which corresponds to the text extracted from the OCR zone comprises (a) sending a target identifier for the AR target and at least some of the text from the OCR zone to a remote processing system; and (b) after sending the target identifier and at least some of the text from the OCR zone to the remote processing system, receiving the AR content from the remote processing system. Example J4 may also include the features of Example J2 or Example J3, or the features of Example J2 and Example J3.

Example J5 includes the features of Example J1, and the operation of using results of the OCR to determine AR content which corresponds to the text extracted from the OCR zone comprises (a) sending OCR information to the remote processing system, wherein the OCR information corresponds to the text extracted from the OCR zone; and (b) after sending the OCR information to the remote processing system, receiving the AR content from the remote processing system. Example J5 may also include the features of Example J2 or Example J3, or the features of Example J2 and Example J3.

Example J6 includes the features of Example J1, and the AR browser is operable to use the AR target as a high-level classifier and to use at least some of the text from the OCR zone as a low-level classifier. Example J6 may also include (a) the features of Example J2, J3, J4, or J5; (b) the features of any two or more of Examples J2, J3, and J4; or (c) the features of any two or more of Examples J2, J3, and J5.

Example J7 includes the features of Example J6, and the high-level classifier identifies the AR content provider.

Example J8 includes the features of Example J1, and the AR target is two dimensional. Example J8 may also include (a) the features of Example J2, J3, J4, J5, J6, or J7; (b) the features of any two or more of Examples J2, J3, J4, J6, and J7; or (c) the features of any two or more of Examples J2, J3, J5, J6, and J7.

1-17. (canceled)

18. At least one machine accessible medium comprising computer instructions for supporting augmented reality enhanced with optical character recognition, wherein the computer instructions, in response to being executed on a data processing system, enable the data processing system to perform operations comprising:
automatically determining, based on video of a scene, whether the scene includes a predetermined augmented reality (AR) target;
in response to determining that the scene includes the AR target, automatically retrieving an optical character recognition (OCR) zone definition associated with the AR target, wherein the OCR zone definition identifies an OCR zone;
in response to retrieving the OCR zone definition associated with the AR target, automatically using OCR to extract text from the OCR zone;
using results of the OCR to obtain AR content which corresponds to the text extracted from the OCR zone; and
automatically causing the AR content which corresponds to the text extracted from the OCR zone to be presented in conjunction with the scene.

19. At least one machine accessible medium according to claim 18, wherein the OCR zone definition identifies at least one feature of the OCR zone relative to at least one feature of the AR target.

20. At least one machine accessible medium according to claim 18, wherein the operation of automatically retrieving an OCR zone definition associated with the AR target comprises:
using a target identifier for the AR target to retrieve the OCR zone definition from a local storage medium.

21. At least one machine accessible medium according to claim 18, wherein the operation of using results of the OCR to determine AR content which corresponds to the text extracted from the OCR zone comprises:
sending a target identifier for the AR target and at least some of the text from the OCR zone to a remote processing system; and
after sending the target identifier and at least some of the text from the OCR zone to the remote processing system, receiving the AR content from the remote processing system.

22. At least one machine accessible medium according to claim 18, wherein the operation of using results of the OCR to determine AR content which corresponds to the text extracted from the OCR zone comprises:
sending OCR information to the remote processing system, wherein the OCR information corresponds to the text extracted from the OCR zone; and
after sending the OCR information to the remote processing system, receiving the AR content from the remote processing system.

23. At least one machine accessible medium according to claim 18, wherein:
the AR target serves as a high-level classifier; and
at least some of the text from the OCR zone serves as a low-level classifier.

24. At least one machine accessible medium according to claim 23, wherein the high-level classifier identifies the AR content provider.

25. At least one machine accessible medium according to claim 18, wherein the AR target is two dimensional.

26. At least one machine accessible medium comprising computer instructions for implementing a multi-level trigger for augmented reality content, wherein the computer instructions, in response to being executed on a data processing system, enable the data processing system to perform operations comprising:
selecting an augmented reality (AR) target to serve as a high-level classifier for identifying relevant AR content; and
specifying an optical character recognition (OCR) zone for the selected AR target, wherein the OCR zone constitutes an area within a video frame from which text is to be extracted using OCR, and wherein text from the OCR zone is to serve as a low-level classifier for identifying relevant AR content.

27. At least one machine accessible medium according to claim 26, wherein the operation of specifying an OCR zone for the selected AR target comprises:
specifying at least one feature of the OCR zone, relative to at least one feature of the AR target.

28. At least one machine accessible medium comprising computer instructions for processing a multi-level trigger for augmented reality content, wherein the computer instructions, in response to being executed on a data processing system, enable the data processing system to perform operations comprising:
receiving a target identifier from an augmented reality (AR) client, wherein the target identifier identifies a predefined AR target as having been detected in a video scene by the AR client;
receiving text from the AR client, wherein the text corresponds to results from optical character recognition (OCR) performed by the AR client on an OCR zone associated with the predefined AR target in the video scene;
obtaining AR content, based on the target identifier and the text from the AR client; and
sending the AR content to the AR client.

29. At least one machine accessible medium according to claim 28, wherein the operation of obtaining AR content, based on the target identifier and the text from the AR client, comprises:
dynamically generating the AR content, based at least in part on the text from the AR client.

30. At least one machine accessible medium according to claim 28, wherein the operation of obtaining AR content, based on the target identifier and the text from the AR client, comprises automatically retrieving the AR content from a remote processing system.

31. At least one machine accessible medium according to claim 28, wherein the text received from the AR client comprises at least some of the results from the OCR performed by the AR client.

32. A data processing system comprising:
a processing element;
at least one machine accessible medium responsive to the processing element;
an augmented reality (AR) browser stored at least partially in the at least one machine accessible medium, wherein the AR browser is operable to automatically determine, based on video of a scene, whether the scene includes a predetermined AR target;
an AR database stored at least partially in the at least one machine accessible medium, wherein the AR database contains an AR target identifier associated with the AR target and an optical character recognition (OCR) zone definition associated with the AR target, wherein the OCR zone definition identifies an OCR zone; and
wherein the AR browser is operable to perform operations comprising:
automatically retrieving the OCR zone definition associated with the AR target, in response to determining that the scene includes the AR target;
in response to retrieving the OCR zone definition associated with the AR target, automatically using OCR to extract text from the OCR zone;
using results of the OCR to obtain AR content which corresponds to the text extracted from the OCR zone; and
automatically causing the AR content which corresponds to the text extracted from the OCR zone to be presented in conjunction with the scene.

33. A data processing system according to claim 32, wherein the OCR zone definition identifies at least one feature of the OCR zone relative to at least one feature of the AR target.

34. A data processing system according to claim 32, wherein the AR browser is operable to use a target identifier for the AR target to retrieve the OCR zone definition from a local storage medium.

35. A data processing system according to claim 32, wherein the operation of using results of the OCR to determine AR content which corresponds to the text extracted from the OCR zone comprises:
sending a target identifier for the AR target and at least some of the text from the OCR zone to a remote processing system; and
after sending the target identifier and at least some of the text from the OCR zone to the remote processing system, receiving the AR content from the remote processing system.

36. A data processing system according to claim 32, wherein the operation of using results of the OCR to determine AR content which corresponds to the text extracted from the OCR zone comprises:
sending OCR information to the remote processing system, wherein the OCR information corresponds to the text extracted from the OCR zone; and
after sending the OCR information to the remote processing system, receiving the AR content from the remote processing system.

37. A data processing system according to claim 32, wherein the AR browser is operable to use the AR target as a high-level classifier and to use at least some of the text from the OCR zone as a low-level classifier.

38. A data processing system according to claim 37, wherein the high-level classifier identifies the AR content provider.

39. A data processing system according to claim 32, wherein the AR browser is operable to detect two dimensional AR targets in video scenes.

40. A method for implementing a multi-level trigger for augmented reality content, the method comprising:
selecting an augmented reality (AR) target to serve as a high-level classifier for identifying relevant AR content; and
specifying an optical character recognition (OCR) zone for the selected AR target, wherein the OCR zone constitutes an area within a video frame from which text is to be extracted using OCR, and wherein text from the OCR zone is to serve as a low-level classifier for identifying relevant AR content.

41. A method according to claim 40, wherein the operation of specifying an OCR zone for the selected AR target comprises:
specifying at least one feature of the OCR zone, relative to at least one feature of the AR target.
